(19) United States
(12) Patent Application Publication
(10) Pub. No.: US 2025/0322541 A1
(43) Pub. Date: Oct. 16, 2025

(54) METHOD FOR RECOGNIZING A SPATIAL ALIGNMENT OF AN OBJECT IN CAMERA DATA

(71) Applicant: Robert Bosch GmbH, Stuttgart (DE)

(72) Inventor: Csaba Marosi, Budapest (HU)

(21) Appl. No.: 19/172,709

(22) Filed: Apr. 8, 2025

(30) Foreign Application Priority Data
Apr. 11, 2024 (DE) 10 2024 203 335.9

(51) Int. Cl. G06T 7/73; G06V 10/24; G06V 10/82

(52) U.S. Cl. CPC G06T 7/74; G06V 10/245; G06V 10/82; G06T 2207/20021; G06T 2207/20081; G06T 2207/20084; G06T 2207/30244; G06T 2207/30252

(57) ABSTRACT

A method for recognizing a spatial alignment of an object in camera data. The method includes: a) providing a regular pattern including a plurality of rows of circular markings on the object; b) recognizing the circular markings in the camera data; c) ascertaining the center of at least two of the circular markings in the camera data; and d) ascertaining a spatial alignment and/or position of the object by finding at least one connecting line of at least two centers recognized in step c).

### BACKGROUND INFORMATION

Correctly recognizing the real world in the environment of a vehicle using sensors is a fundamental challenge in the development of systems for highly automated and autonomous driving of motor vehicles.

Such systems typically comprise neural networks with which sensor data obtained from the environmental sensors of the motor vehicle are analyzed and evaluated.

The development of such systems therefore requires, in particular, a very large amount of training data that can be used for training neural networks. Such data are also designated as “labeled data.” This means that certain information is known for the data, which a neural network is supposed to independently recognize from comparable data. Such data are needed for training neural networks, because such data can be used to introduce information into neural networks. Regular so-called “ground truth” data are required to train neural networks for evaluating sensor data of a vehicle. Such data show where certain objects in the environment of the vehicle, which can be recognized by the sensors of the vehicle, are actually positioned in a ground-referenced coordinate system describing the environment of the motor vehicle. Sensors in the motor vehicle can only recognize objects from the particular viewing perspective of the sensor from the motor vehicle. With the aid of “ground truth” data related to such objects, neural networks can be trained to evaluate sensor data from such sensors in order to reliably recognize the position of objects in the ground-referenced coordinate system for describing the environment of the motor vehicle.

Obtaining such “ground truth” data is complex. A conventional approach is to obtain such data with the aid of a drone that accompanies a vehicle that is carrying out test drives to obtain data for training neural networks. Such a drone preferably hovers above the test vehicle during the test drive. Preferably, such a drone is equipped with a camera that recognizes the test vehicle and its environment along with the objects in this environment. Due to the top-down perspective with which such a camera views the vehicle and the objects, ground truth data can be recognized much more easily and accurately with such a drone and its camera, using less complex evaluation systems than are required for the evaluation of data from sensors on the motor vehicle. By positioning a drone at an adjustable distance above the vehicle, obtaining training data in this way is highly advantageous—in particular if the training data to be obtained comprise the described “ground truth” data.

When using drones to obtain training data, it is often necessary to be able to determine the relative position between the drone and the test vehicle very precisely. This is particularly necessary in order to be able to correctly align the camera image of the drone in a coordinate system of the test vehicle. In particular, an (unrecognized) rotational shift of the drone relative to the motor vehicle is regularly problematic for the use of camera images recorded with the drone to obtain training data. For example, an angular error of 0.1 degree leads to relative (false) displacements of up to 10 cm of objects that are 50 meters away from the test vehicle. However, the recognition of positions of objects in the surrounding area of a vehicle with on-board sensors in the centimeter range is a goal that should be achieved by appropriate training of neural networks for evaluating sensor data from such sensors. Thus, training data must achieve comparable or even higher accuracy.

### SUMMARY

An object of the present invention to at least partially solve the problems described with reference to the related art. This object may be achieved by certain features of the present invention. In particular, a method for recognizing the spatial alignment of objects in camera data will be described. Further advantageous embodiments of the present invention are disclosed herein. It should be noted that a person skilled in the art combines the individual features in a technologically meaningful manner and thus arrives at further embodiments of the present invention.

The present invention relates to a method for recognizing a spatial alignment of an object in camera data. According to an example embodiment of the present invention, the method includes the following steps:
a) providing a regular pattern comprising a plurality of rows of circular markings on the object;
b) recognizing the circular markings in the camera data;
c) ascertaining the center of at least two of the circular markings in the camera data; and
d) ascertaining a spatial alignment and/or position of the object by finding at least one connecting line of at least two centers recognized in step c).

According to an example embodiment of the present invention, it is particularly advantageous if the regular pattern is arranged on the roof of a vehicle, the spatial alignment and/or position of which is recognized in the camera data. The described object, the alignment and/or position of which is recognized, is therefore in particular a vehicle and most preferably a motor vehicle.

According to an example embodiment of the present invention, it is also advantageous if the camera data was recorded with a camera on a flyable drone in an observation position above the vehicle.

The method is used in particular in the context of processing data from a drone flying above the motor vehicle for the creation of training data for training systems (or neural networks contained therein) for the evaluation of sensor data from sensors (in particular from environmental sensors) for monitoring the environment of a motor vehicle. The method is used in particular to generate ground truth data, which are configured to train such systems to recognize positions and distances of objects in the environment of a motor vehicle.

Video data obtained with a drone and the objects recognized therein, and their position and alignment, can best be described in a coordinate system that is specified based on the drone, for example with a center on an axis aligned with the camera on the drone and further axes in a ground plane on which the observed object (the motor vehicle) is also located. Such a coordinate system is also referred to here as a drone coordinate system.

Sensor data from sensors on the motor vehicle are normally available in coordinate systems related to the motor vehicle, which are regularly aligned based on the longitudinal and transverse directions of the motor vehicle and can also be referred to as vehicle coordinate systems. The spatial alignment of an object to be recognized in the camera data refers in particular to the spatial orientation of the object in the camera data. In particular, the aim is to recognize how a vehicle coordinate system is aligned relative to the drone coordinate system.

The approach of the described method of the present invention is that the alignment of the object can be recognized in the camera data based on the markers on the object or the test vehicle. These markers can be evaluated in camera data in order to automatically determine the alignment of the object. Based on this, the position of other objects in the environment of the object, which are initially recognized in the camera data in the drone coordinate system, can then be converted and/or transferred into the vehicle coordinate system.

In other applications, a checkerboard pattern of white and black squares arranged on the roof of a test vehicle has already been used. This checkerboard pattern can be recognized in the camera image of a drone hovering above the test vehicle. The alignment of the camera image relative to the vehicle can be carried out based on this checkerboard pattern. In the past, when recognizing spatial alignments based on such a checkerboard pattern, edges of the individual tiles of the checkerboard pattern and/or corners where individual tiles of the checkerboard pattern meet were regularly recognized.

It has been found that this can be a problem in particular in light of the resolution of the camera image. In particular, if the entire checkerboard pattern is described by not very many image pixels, edges and/or corners of tiles can no longer be reliably recognized. Then it is more difficult to recognize alignments based on edges and/or corners of tiles.

Here, it is proposed according to an example embodiment of the present invention to provide a regular pattern of circular markings on the basis of which the spatial alignment can be recognized. The circular markings are recognized and in each case a center is determined for the circular markings. The determination of the circle is much less dependent on the alignment of a pixel grid of the camera data with the alignment of the regular pattern.

At low resolutions, the recognition of centers is possible with particular reliability. This is particularly successful regardless of the alignment if the pixels in the camera image are arranged in a rectangular grid.

The centers of circular markings are, in particular, also spaced farther apart from one another than the corners of tiles in a checkerboard pattern. For this reason, longer connecting lines can be found, which further improves the recognition of spatial alignment.

Furthermore, according to an example embodiment of the present invention, it is advantageous if the regular pattern comprises an arrangement of the circular markings in a hexagonal grid with rows of circular markings that are arranged in a manner offset from one another in the individual rows.

The hexagonal arrangement offers the maximum distance between the centers of the individual tiles in a small space, so that such an arrangement is particularly advantageous for the method described here.

Furthermore, according to an example embodiment of the present invention, it is advantageous if the regular pattern has rows of three comprising three circular markings and rows of two comprising two circular markings.

According to an example embodiment of the present invention, it is also advantageous if the pattern is designed with five rows of circular markings.

According to an example embodiment of the present invention, it is also advantageous if the pattern has two rows of three and three rows of two circular markings.

According to an example embodiment of the present invention, it is also advantageous if the pattern comprises the following arrangement of rows arranged next to one another:
first row of three with circular markings;
first row of two with circular markings that are arranged in a manner offset from the circular markings of the first row of three;
second row of three, the circular markings of which are aligned correspondingly with the circular markings of the first row of three;
second row of two, the circular markings of which are aligned correspondingly with the circular markings of the first row of three; and third row of two, the circular markings of which are aligned correspondingly with the circular markings of the rows of three.

According to an example embodiment of the present invention, it is further advantageous if step c) is performed with a “blob detector” algorithm.

So-called “blob detector” algorithms can be used to recognize the center of a circle. There are highly accurate algorithms for finding the center of a circle, which are described under the term “blob detector.”

Furthermore, according to an example embodiment of the present invention, it is advantageous if step d) is performed with a Perspective-n-Point algorithm.

Once the centers of a plurality of circles have been ascertained, a so-called Perspective-n-Point algorithm can be used in order to ascertain the position and orientation/spatial alignment between the drone's camera image and the test vehicle.

It was found that even at very low resolutions of, for example, 50×30 pixels showing the pattern of markings, the standard deviation of the recognized alignments is very small. In particular, a deviation due to an unfavorable alignment of the pixel grid of the camera data is much smaller than with other types of markings, such as the described markings in a checkerboard-like grid.

Also to be described here is a data processing device, comprising a processor which is adapted and/or configured to carry out the described method of the present invention.

Further described is a computer program product, comprising commands which, when the computer program product is carried out by a computer, cause said computer to carry out the described method of the present invention.

Further described is a computer-readable storage medium, comprising commands which, when carried out by a computer, cause said computer to carry out the described method of the present invention.

The present invention and the technical environment of the present invention are explained in more detail below with reference to the figures. The figures show preferred exemplary embodiments, to which the present invention is not limited. It should be noted, in particular, that the figures and in particular the size proportions shown in the figures are only schematic.

### BRIEF DESCRIPTION OF THE DRAWINGS

FIG. 1 is a schematic representation of a drone observing a vehicle, according to an example embodiment of the present invention.

FIG. 2A shows a panel with a pattern of rectangular markings for recognizing a spatial alignment, according to an example embodiment of the present invention.

FIG. 2B shows a principle for recognizing a spatial alignment based on the pattern from FIG. 2A, according to an example embodiment of the present invention.

FIG. 3 shows a panel with a pattern of circular markings for recognizing a spatial alignment, according to an example embodiment of the present invention.

FIG. 4 shows a principle for recognizing a spatial alignment based on the pattern from FIG. 3.

FIG. 5 schematically shows a sequence of the described method according to an example embodiment of the present invention.

### DETAILED DESCRIPTION OF EXAMPLE EMBODIMENTS

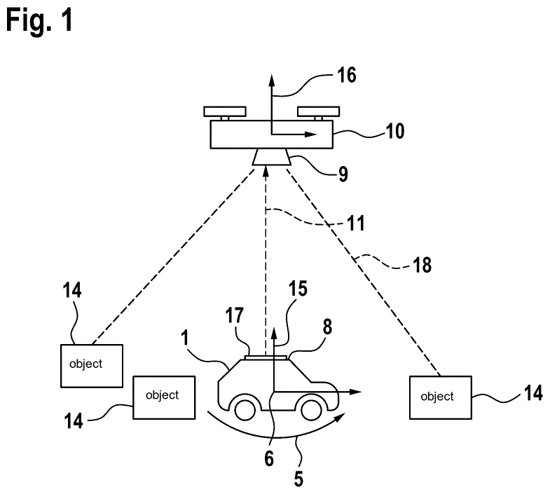

FIG. 1 is a schematic representation of a drone 10 that accompanies a vehicle 1 and observes from an observation position 11 above the vehicle 1. The drone has a camera 9 that has a downward-facing field of view 18 and with which camera data can be generated in which the vehicle 1 and other objects 14 in the surrounding area of the vehicle 1 are recognizable/visible. Camera data obtained with the camera 9 on the drone 10 are present in a drone coordinate system 16, which is indicated schematically here on the drone 10, but which can also be projected onto the ground on which the vehicle 1 is located. The camera data will be used to calibrate sensors (not shown separately here) on the vehicle 1 or to improve algorithms for evaluating the data from such sensors. Data obtained with sensors on the vehicle 1 are available in a vehicle coordinate system 15. In order to use the camera data from the camera 9, a conversion from the vehicle coordinate system 15 to the drone coordinate system 16 and/or vice versa is required. In order to make this conversion possible, the alignment 5 and the position 6 of the vehicle 1 in the camera data 9 or relative to the camera 9 of the drone 10 must be known. Here, it is proposed to provide a panel 17 with a pattern (not shown here) on the roof 8 of the vehicle 1. This pattern on the panel 17 can be recognized and evaluated in the camera data in order to determine in particular the alignment 5 and, if applicable, also the position 6 of the vehicle 1 in the camera data.

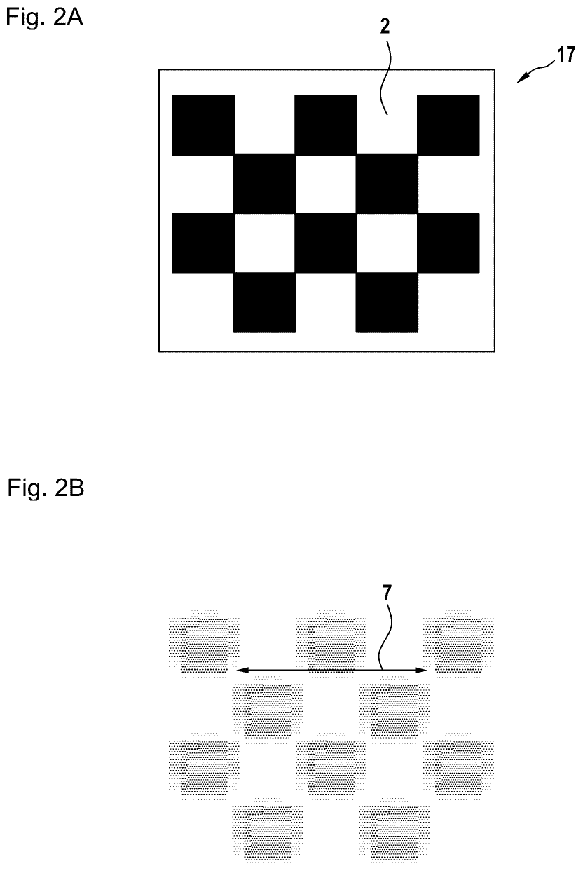

FIG. 2A shows a first embodiment variant of a panel 17 with a regular pattern 2, which is not the subject of the present invention here. The regular pattern 2 is formed here by rectangular markings. FIG. 2B shows how this regular pattern 2 can be evaluated for recognizing an alignment. Edges or corners of the rectangular markings can be found and connecting lines 7 of these edges or corners can be found in order to determine an alignment. The regular pattern 2 is available in camera data and can be seen in FIG. 2B. Camera data represent the camera image in the form of pixels in a pixel grid. As a result, edges of structures shown in the camera data may be distorted. This distortion is subject in particular to a dependency on the alignment of the pixel grid of the camera data. In particular, when recognizing a pattern of rectangular markings, an (unknown) alignment of the pixel grid relative to the alignment of the rectangular markings can generate undesirable directional dependencies.

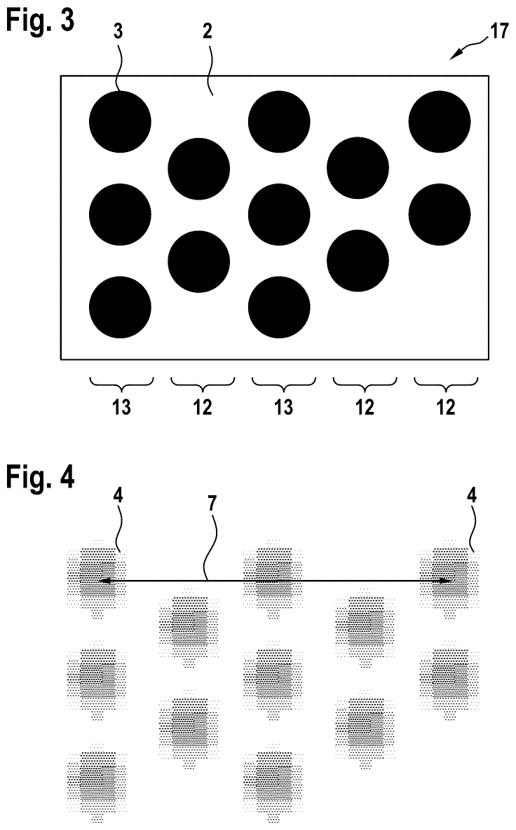

The embodiment variant of the panel 17 shown in FIG. 3 can be used for the present invention described here. Here, the markings are circular markings 3 that are arranged in a regular pattern 2. The regular pattern 2 is a hexagonal pattern of rows 12, 13 of circular markings 3, arranged in a manner offset from one another. Rows of two 12 and rows of three 13 circular markings 3 are provided. FIG. 4 shows how such a regular pattern 2 of circular markings 3 is available in camera data. The pixelation of the regular pattern 2 in the camera data can also be seen here. Due to the circularity of the circular markings 3, a direction-dependent effect of the pixel grid is significantly reduced compared to the situation shown in FIG. 2B. Using special tested and proven algorithms, it is possible to ascertain centers 4 of circular markings 3 in each case. Connecting lines 7 can be found between centers 4 in order to determine spatial alignment.

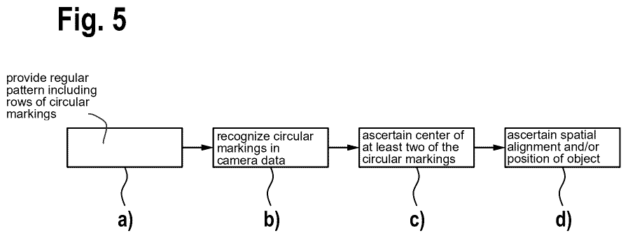

FIG. 5 schematically shows a flow diagram of the described method as it can be carried out in a device for data processing and for evaluating the camera data. Method steps a), b), c) and d), which are carried out one after the other, can be seen.

1-13. (canceled)

14. A method for recognizing a spatial alignment of an object in camera data, comprising the following steps:
a) providing a regular pattern including a plurality of rows of circular markings on the object;
b) recognizing the circular markings in the camera data;
c) ascertaining a center of each of at least two of the circular markings in the camera data; and
d) ascertaining a spatial alignment of the object and/or position of the object by finding at least one connecting line of at least two of the centers recognized in step c).

15. The method according to claim 14, wherein the regular pattern is arranged on a roof of a vehicle, the spatial alignment and/or position of the vehicle being recognized in the camera data.

16. The method according to claim 15, wherein the camera data were recorded with a camera on a flyable drone in an observation position above the vehicle.

17. The method according to claim 14, wherein the regular pattern includes an arrangement of the circular markings in a hexagonal grid with the rows of the circular being arranged in a manner offset from one another in individual rows.

18. The method according to claim 14, wherein the regular pattern has rows of three including three circular markings and rows of two including two circular markings.

19. The method according to claim 14, wherein the pattern has a total of five rows of circular markings.

20. The method according to claim 19, wherein the pattern has two rows of three circular markings and three rows of two circular markings.

21. The method according to claim 20, wherein the pattern includes the following arrangement of adjacent rows:
a first row of three with circular markings;
a first row of two with circular markings that are arranged in a manner offset from the circular markings of the first row of three;
a second row of three, the circular markings of which are aligned correspondingly with the circular markings of the first row of three;
a second row of two, the circular markings of which are aligned correspondingly with the circular markings of the first row of three; and
a third row of two, the circular markings of which are aligned correspondingly with the circular markings of the rows of three.

22. The method according to claim 14, wherein step c) is performed with a “blob detector” algorithm.

23. The method according to claim 14, wherein step d) is performed with a Perspective-n-Point algorithm.

24. A data processing device, comprising:
a processor which is configured to recognize a spatial alignment of an object in camera data, the processor configured to:
a) provide a regular pattern including a plurality of rows of circular markings on the object;
b) recognize the circular markings in the camera data;
c) ascertain a center of each of at least two of the circular markings in the camera data; and
d) ascertain a spatial alignment of the object and/or position of the object by finding at least one connecting line of at least two of the centers recognized in c).

25. A non-transitory computer-readable storage medium on which are stored commands for recognizing a spatial alignment of an object in camera data, the commands, when executed by a computer, causing the computer to perform the following steps:
a) providing a regular pattern including a plurality of rows of circular markings on the object;
b) recognizing the circular markings in the camera data;
c) ascertaining a center of each of at least two of the circular markings in the camera data; and
d) ascertaining a spatial alignment of the object and/or position of the object by finding at least one connecting line of at least two of the centers recognized in step c)0.
